(19) United States
(12) Patent Application Publication
(10) Pub. No.: US 2017/0046545 A1
(43) Pub. Date: Feb. 16, 2017

(54) MOBILE SYSTEM FOR AUTOMATICALLY COLLECTING THE FEE FOR THE USE OF REGULATED PARKING SPACES

(71) Applicant: ESTACIONAMIENTOS Y SERVICIOS S.A.U., Madrid (ES)

(72) Inventor: Julio Angel BRAVO SANCHEZ, Madrid (ES)

(73) Assignee: ESTACIONAMIENTOS Y SERVICIOS S.A.U., Madrid (ES)

(21) Appl. No.: 15/306,348

(22) PCT Filed: Apr. 25, 2014
(86) PCT No.: PCT/ES2014/070367

§ 371 Date: Oct. 24, 2016

(51) Int. Cl. G06K 7/10; G08G 1/017; G07B 15/02; G06K 9/00

(52) U.S. Cl. CPC G06K 7/10376; G06K 9/00825; G08G 1/0175; G07B 15/02; G06Q 2240/00; G08G 1/065

(57) ABSTRACT

The system is based on the reading of tags or licence plates, carried out by a moving remote reader (1) arranged on a vehicle (2) or carried by control staff (3), used to read the tag (4) or licence plate of a vehicle (5) parked in a regulated parking space above ground (6), geographically located by the GPS (14), in such a way that a camera (15) records the image corresponding to the vehicle (5) such that the combination of the data corresponding to the processing of the position captured by the GPS (14) and the identification captured by the reader (1) allows the computer system to not only establish the type of parking space, but also to calculate and collect automatically the fee corresponding to the parked vehicle (5), without requiring the user to use other form of payment.

### OBJECT OF THE INVENTION

The present invention relates to a system which has been especially conceived for automatically collecting the fee for using regulated parking spaces in order for this task to be carried out in a comfortable manner for the user without having to have loose money or having to spend a certain amount of time locating and going to the corresponding parking meters.

It is thus the object of the invention to provide a system which allows the use of identifier systems installed in vehicles parked in a regulated parking space and more specifically an on-board or portable mobile system which allows the active or passive electronic TAG or RFID (radio frequency identification) elements located in the vehicles parked on the public or private roads in regulated parking areas to be read remotely, or where appropriate, the licence plates of said vehicles, previously registered in the system, to be read such that the system carries out the location control and automatic collecting of the fee associated with the time used by the vehicles parked in that space.

The on-board or portable reader system is accompanied by GPS localisation systems or similar, by photo or video cameras, which show the position of the element associated with the TAG that has been read, or identify the data of the user by means of their licence plate, and by centralized computer techniques which calculate the guidance so that the vehicles and staff who carry said TAG reader system optimally follow the geographic routes where there are vehicles parked with said TAGs in order to carry out the collection with the required frequency.

### BACKGROUND OF THE INVENTION

Within the field of practical application of the invention, i.e. the regulated parking areas, it is known to use parking meters to carry out the payment of said regulated parking.

These types of devices are sometimes subjected to acts of vandalism, becoming inoperable, in addition to only allowing payment with coins such that the drivers do not always have change, along with the problems that this entails.

More importantly, the cost of these types of parking meters is considerably high, therefore they are usually arranged at certain distances, in some cases excessive distances, which sometimes means that they are not visible to the user, having to walk long distances to carry out the payment with the consequent and negative impact that this entails in present society where “time is money”.

In other fields, it is known to use arches equipped with cameras and TAG readers located at transit points such as highways to collect tolls, reading these devices located in the vehicles which pass through the arch as well as collecting for the access to underground parking areas.

Similarly, in other fields, portable or on-board systems are known for reading Tags or RFIDs to control goods in warehouses in the field of logistics, rubbish collection, businesses and others.

However, on-board or portable systems for reading TAGs or using any other means for identifying vehicles equipped with a computer system which help to automatically collect for the usage time of the regulated parking space above ground are not known.

### DESCRIPTION OF THE INVENTION

The system which is defined will fill the previously mentioned gap and is based on the combined operation of using an on-board or portable device equipped with a TAG reader equipped with an antenna for transmitting a signal which, upon being directed a distance of a few meters, reaches a TAG label or another electronic identification system equipped with an electromagnetic coil which incorporates a chip which is excited and responds with a unique identification in the form of a return electromagnetic signal which is analysed and processed by the reader device and equipped with a GPS system or similar that is also on-board or portable which adds the geographic coordinates to the identification and equipped with a photo or video camera system that is also on-board or portable, which show the vehicle or object carrying the TAG and equipped with a computer system which communicates, analyses and uses the data received regarding identification, position, date, time and images in order to optimally manage a regulated parking environment in public.

The TAG reader is a standard reader which may have different forms which allow it to be installed in fixed or mobile locations such as in vehicles even being a portable size so that it may be transported by a staff member. The RFID TAG readers transmit an electromagnetic signal in a determined frequency and a distance of approximately 10 meters at most and with the specific codification that excites the TAG which, in the form of a label, will respond immediately, identifying the element to be controlled.

The TAG may have passive or active characteristics and will be associated computationally to data which identify the vehicle or object which carries it in an integral manner in any location whether or not it is visible, adhered, magnetized, inserted or embedded.

GPS or other satellite or location triangulation systems may supply the standard geographic coordinates of the vehicle with greater or lesser precision and use this information to mathematically estimate the position where the TAG that has been read actually is.

The photo or video camera(s) are used in the system to obtain the evidence of the presence of the vehicle in this location and in order to be able to compare the visible data of the licence plate and make and model and colour of the vehicle crosschecking it with the information relating to the identification supplied by the TAG.

This equipment may preferably also be used to identify the payment data of the user, registered in the system by means of the licence plate of the vehicle itself which will be registered in the corresponding database of the system.

The central computer system has the information to crosscheck the data of the identification number of the TAG or licence plate with the registered data of the vehicle created at the time of registering the user in the system and the delivery and installation thereof in the vehicle to be controlled. It also receives the information of the identifiers read by the TAGs together with the GPS positions and photographs from the reader systems. It also has the logic required to apply and collecting the value of any formula defined in the usage fee of this regulated parking area with the data received regarding identification and location or other parameters related to values of pollution, the occupancy levels or others. It also has sufficient capacity to carry out processes for calculating route optimization, detecting areas with lesser or greater control and analysing the frequency required for control, sending signals to those carrying reader systems to optimize their work.

The combination of these control devices: TAG reader/licence plate reader, geographic positioning, image capture and computer system, together with the identification elements associated with a fleet of vehicles for private or public transport, transport of staff or goods, of a professional group or security or civilian transport or transport of a whole country, or visitors, even carried by staff, bicycles, motorbikes, cars, vans, trucks or vessels, but also by other stationary elements such as containers and urban furniture, allows computer registration of the time and space used by the object associated with said element to be provided.

This consolidated system of control devices together with the identification devices is combined in this invention to automatically charge for the time used in the public spaces. This collection may be carried out each time that the control devices satisfactorily identify an element, automatically applying the official fees which regulate the use of the individual space for this element and space. These fees may charge minimum stay values supplemented by the remaining times that the element is identified in this space, curves being followed which relate the price with the total stay time calculated, penalising or crediting depending on the different regulation parameters.

Once the amount to be collected is known, the collection for the service should be carried out using a payment system or established payment gateway or by means of other external services which share the same identification of the user such that the system does not necessarily handle the amounts collected, but rather uses computer services associated with the issuing entity of the system.

The system is also used to find out the approximate occupancy of the public spaces as well as the precise billing, all in real time. Likewise, the information received in the system sent by the rest of the reader systems in real time may be used to inform the drivers in order to divert the traffic towards areas with less congested occupancy in terms of parking occupancy, even showing this information on panels.

Since the system resolves the automatic collection, this invention removes the need for the user to have to locate a parking meter or to have an alternative payment system such as mobile or similar and use it each time that they use a parking space. Since it is an activity whose governmental regulation requires the payment, the automation of the collection is plausible.

The system proposed in this invention may send the registered user and who installs the corresponding application, information regarding the usage time, location and price paid, together with alerts of excess time if there were any. The system is supplemented by a software application which allows the user to receive these notifications and alerts, the user may even interact by indicating when the use of the space has ended in order to decrease the price of the time charged by the automatic system. In the event that the automatic system identifies the element in the same space after the user manually sends the communication regarding the ending of use, a penalty is issued or a greater amount is collected due to the offence committed. The user can always notify the system of the location and start or end of the use of the space.

The processing of the data captured together with the identification, in a combined manner, allow the problem of automatic charging for the parking space to be resolved as well as the type of vehicle which occupies this space and in general the measuring of the occupancy of the public space.

That is to say, the problem of how to automate the collection of the municipal fees is resolved by means of the system of the invention with the advantage of avoiding the direct intervention of the citizen since the different existing systems are based on the installation of vending machines or parking meters and different mobile applications which are normally used by citizens such that by means of the invention it will be possible to automatically detect the elements which occupy each space, taking note of the type of parking space and the identification of the vehicle which occupies it, simply by consulting the centralised computer system which contains the information regarding these rights, applying the corresponding fee and charging for the service, where the municipal or governmental regulation so allows.

By way of example, the system of the invention can check whether a vehicle is occupied by a disabled user or whether it is a resident in the area or is parked on a private road or in a loading or unloading location or whether it has the relevant permit required for this type of space and automatically apply the price according to the fee, or the penalty associated with the type of irregularity detected and notify the information in order to carry out other complementary arrangements.

In addition, with the same identification, it is possible to consult and send the data to other public or private computer systems which carry out other validations or analyses such as registration certificates of the vehicle, search for stolen vehicle, status of mandatory insurance, technical inspections, vehicle registry, university cards, businesses, rental, taxi drivers, dealers, market analysis and research, etc.

The complete identification and collection system described in this invention is based on the premise that all the vehicles with the possibility to park in the regulated public spaces or the vast majority of them, have an electronic TAG which identifies them, for which there should be a specific delivery and activation process for said TAG. During the delivery process, the vehicle must be associated with a payment method. The payment methods may be associated with businesses or physical persons responsible for the identified property.

This system may benefit from the synergies of using identification systems by means of TAG present and deployed for other uses, by other public or private bodies. As an example, TAGs transmitted for charging on highways may be used for the automatic payment for parking as is described in this invention.

In the case where the reader elements do not satisfactorily carry out the identification of the TAG, for different reasons, for example there is none or it has deteriorated or there is interference or any other reason, the system proposed in the present invention will send the photograph together with the error notification so that it is manually or automatically analysed and the appropriate measures are taken.

The existence of the images of the vehicle or element together with the identification of the TAG allows subsequent verification, for security reasons, that both systems are consistent with each other, analysing the images using methods which read the licence plates, make and model of the vehicle or other characteristics of the element. This analysis may be carried out manually or in a programmed manner, locally or remotely.

Evidently, by means of the system of the invention, it is possible to implement different uses with the identification of new TAGs in the future in order to determine new groups of users or objects in parking spaces which may or may not be currently regulated or for specific identification systems of the same space, having a TAG which identifies it, therefore the fixed identification thereof will be a further parameter in the integration of the system and which will be used to determine with greater accuracy the location and the use of the space and which will be definable for each city or area by means of configuring the usage parameters thereof.

The same use may be given for identifying and positioning other stationary urban elements such as streetlamps, benches, panels, bus shelters, signals, sewer entrances as well as dynamic displaceable elements such as rubbish containers, site containers, fencing, etc. . . . the TAG only has to be adhered to or integrated in said element and the combined system of this invention uses it to locate and regulate the use of the public space.

By means of the processing software of the system of the invention it is possible to know the position of one or various vehicles or staff that carry the elements of the reader part in order to direct them in real time or in a pre-programmed manner to the locations where identifications are to be carried out. This directed guidance process is carried out taking into account the position of each reader device combined with the frequencies necessary for passing through each area or section so that collection is optimal. The system is capable of calculating the number of vehicles required for carrying out the control functions, taking note of the state of the traffic, weather and the characteristics of each one of the vehicles themselves carrying the reader system whether they are staff, bicycles, motorbikes or any other vehicle.

Obviously the system described is not ruled out for use in parallel with other collection systems depending on the preferences of each user.

### DESCRIPTION OF THE DRAWINGS

In order to complement the description that is going to be made below and with the object of helping to better understand the characteristics of the invention, in accordance with a preferred practical embodiment thereof, said description is accompanied, as an integral part thereof, by a set of drawings where, in an illustrative and non-limiting manner, the following has been represented:

FIG. 1 shows a schematic block diagram of the mobile or on-board device which cooperates in the system object of the present invention;

FIG. 2 corresponds to a perspective view of the application of the system in which a parked vehicle is illustrated, the parking of which is managed automatically or by a manually transportable portable device or by a control vehicle equipped with said device when said vehicle has been registered in the system of the invention.

### PREFERRED EMBODIMENT OF THE INVENTION

As can be seen in the referenced figures, the system of the invention comprises a reader (1) aboard a control vehicle (2) or a portable reader carried by a control staff member (3) both capable of moving such that in a preferred embodiment of the invention, vehicles registered in the system are supplied with a radio frequency identification card or TAG (4) which is installed in said vehicle (5) which is capable of being parked in a parking space (6) such that it is possible to identify the user from said reader (1) and carrying out the collection for the corresponding service.

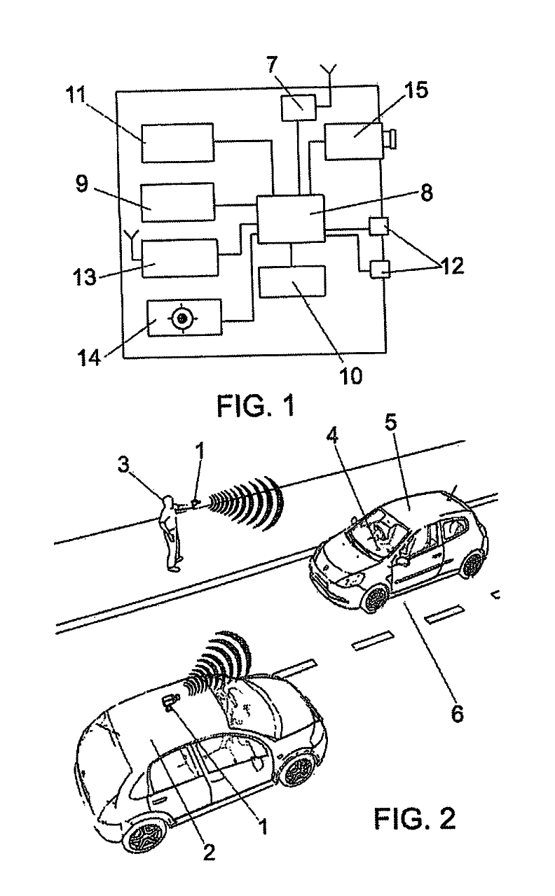

To this end, in accordance with FIG. 1, the reader (1) has an RFID reader module (7) associated with a microprocessor (8) with the corresponding internal memory thereof (9), power source /battery (10) and the normal control electronics, it may have means for storing removable memory (11) as well as connection ports (12) for dumping data and updating the software.

In any case, the reader (1) also includes a communications module (13) with the main server and computer system, a GPS module (14) and a camera or video camera (15).

Based on this structuring, the reader (1) identifies the TAG (4) and associates said reading with the geographic location by means of GPS (14), while the camera (15) records the image corresponding to the vehicle (5) such that the combination of the data corresponding to the processing of the position captured by the GPS (14) and the identification captured by the reader (1) allows the computer system to establish not only the type of parking space, but also to calculate and automatically collect the fee corresponding to the parked vehicle (5), without requiring the user to use other payment means, for this purpose the reader (1) is connected to said system by means of the communications module (13).

The parking space (8) may likewise have a TAG label installed with the aim that when it is read with the same reader system (1) and in a simultaneous manner, the location of the TAG (4) of the vehicle (5) is associated precisely by using the fixed and known position of the space (6), with the aim of increasing the precision which may be obtained by using the GPS module (14).

Evidently, the camera (15) may be used for performing the functions of identifying the licence plate of the vehicle (5), with the identification of which the automatic collection may also be carried out if there is a known and computerised relation between the licence plate and the administered payment means, all of which by means of the central computer system such that it is not strictly necessary to have to have a radio frequency identifier or TAG (4).

As a result, it concerns the simultaneous use of the data corresponding to the identification of the parked vehicle (5) with the data of the location or space (6) where it is located, data which the central computer system uses together with other external parameters to calculate the price which should be charged.

Based on the data which reach the central computer system, the same allows the position of all the elements identified in the system itself to be controlled whether they are those located or identified as those that are locatable, using said position to specify the routes and times which facilitate the collection in an optimal manner.

1. A mobile system for automatically collecting the fee for the use of regulated parking spaces, applicable to regulated parking spaces established in public places with the main aim of calculating and collecting automatically the fee corresponding to the combination of the characteristics of said parking space and the data of the vehicle identified, characterised in that a central server or system cooperates in the same, by means of which a plurality of readers (1) communicate, whether manual or aboard a control vehicle (2), readers (1) in which a microprocessor (8) is set up, with the corresponding internal memory thereof (9), power source/battery (10) and normal control electronics, said reader (1) including a communications module (13) with the main computer system as well as means for identifying the vehicle previously registered in the system, the main system having software for automatically charging the users depending on the data received by the readers (1).

2. The mobile system for automatically collecting the fee for the use of regulated parking spaces according to claim 1, characterised in that the means for identifying the vehicle (5) registered in the system are implemented in an RFID reader module (7) installed in the readers (1), complementing a label or TAG (4) that can be installed in the vehicle (5) of the user.

3. The mobile system for automatically collecting the fee for the use of regulated parking spaces according to claim 1, characterised in that the means for identifying the vehicle (5) registered in the system are implemented in a camera or video camera (15).

4. The mobile system for automatically collecting the fee for the use of regulated parking spaces according to claim 1, characterised in that the readers (1) incorporate a GPS module (14).

5. The mobile system for automatically collecting the fee for the use of regulated parking spaces according to claim 1, characterised in that the readers (1) incorporate means for storing removable memory (11) as well as connection ports (12) for dumping data and updating the software.

6. The mobile system for automatically collecting the fee for the use of regulated parking spaces according to claim 1, characterised in that the parking spaces (6) have a TAG label installed that can be read in parallel with the TAG (4) of the vehicle parked in the same, identifying the exact geographic location at which said space is located.
